(19) United States
(12) Patent Application Publication
(10) Pub. No.: US 2025/0149204 A1
(43) Pub. Date: May 8, 2025

(54) WIRE PROTECTOR FOR HIGH-VOLTAGE WIRE

(71) Applicants: HYUNDAI MOTOR COMPANY, Seoul (KR); KIA CORPORATION, Seoul (KR); YURA CORPORATION CO., LTD., Seongnam-si (KR)

(72) Inventors: Jin Hyeok Kim, Hwaseong-si (KR); Jeong Min Cho, Hwaseong-si (KR); Gi Wook Kim, Hwaseong-si (KR); Hyun Ki Lee, Seoul (KR); Woo Won Jung, Osan-si (KR)

(73) Assignees: HYUNDAI MOTOR COMPANY, Seoul (KR); KIA CORPORATION, Seoul (KR); YURA CORPORATION CO., LTD., Seongnam-si (KR)

(21) Appl. No.: 18/937,902

(22) Filed: Nov. 5, 2024

(30) Foreign Application Priority Data
Nov. 7, 2023 (KR) 10-2023-0152861

(51) Int. Cl. H01B 7/40; B60R 16/02

(52) U.S. Cl. CPC H01B 7/40; B60R 16/0215

(57) ABSTRACT

The present disclosure relates to a movable protector for fixing a high-voltage wire used for a vehicle, which improves an operation of fastening a high-voltage connector using a movable clip absorbing a wiring slack length of, and maintaining a path for, the high-voltage wire.

### CROSS-REFERENCE TO RELATED APPLICATION

This application claims the benefit of and priority to Korean Patent Application No. 10-2023-0152861, filed on Nov. 7, 2023, which is hereby incorporated by reference as if fully set forth herein.

### BACKGROUND

### Technical Field

The present disclosure relates to a movable protector fixing a high-voltage wire used for a vehicle.

### Discussion of Related Art

As the demand for electric vehicles has been rising recently, replaceable high-voltage batteries are necessarily provided in electric vehicles and used as energy storage devices.

A high-voltage battery transfers a high voltage of 300 volts (V) or greater to an electric motor to drive a vehicle. To transfer the high-voltage of the battery to the electric motor, the battery is connected to an inverter or junction box through a high-voltage wire.

Particularly, as the voltage has been increased recently to improve the performance of an electric vehicle, a high-diameter wire that is not readily bendable is mainly used.

When connecting a connector of the high-diameter wire to the inverter or junction box of the vehicle, however, there may be difficulty in a fastening operation due to the tension of the wire, and there is therefore a need for a solution to this problem.

The preceding description of the related art is intended to provide a better understanding of the background of the present disclosure and should not be taken as an admission of the related art known to those having ordinary skill in the art.

### SUMMARY OF THE PRESENT DISCLOSURE

To solve the preceding technical problems, an object of the present disclosure is to provide a movable high-voltage wire protector that may improve workability by employing a movable clip for absorbing a high-voltage wiring slack length and maintaining a path inside the protector to improve fastening difficulty due to the slack length of a high-voltage connector fastening portion (i.e., a wiring slack length based on vehicle rolling or movement).

According to at least one embodiment of the present disclosure, there is provided a movable high-voltage wire protector including a clip mounted on a wire, a housing configured to receive the clip, fixed to a vehicle body and having both longitudinal ends open for the wire to pass therethrough, and a stopper provided on either longitudinal end of an inner surface of the housing to limit a longitudinal movement of the clip inside the housing.

According to at least one embodiment of the present disclosure, the clip may include a ball portion having a through-hole.

According to at least one embodiment of the present disclosure, the ball portion comprises at least two segmented ball portions comprising a first segmented ball portion and a second segmented ball portion, wherein the first segmented ball portion has a plurality of first hook holes, and the second segmented ball portion has a plurality of first hooks configured to be coupled to the plurality of first hook holes.

According to at least one embodiment of the present disclosure, when the plurality of first hooks is coupled to the plurality of first hook holes, the first segmented ball portion and the second segmented ball portion may be coupled while enclosing an outer surface of the wire.

According to at least one embodiment of the present disclosure, the first segmented ball portion and the second segmented ball portion may each further include a corrugated groove formed on an inner surface of the through-hole. The corrugated groove is configured to be coupled between corrugations of the wire when the first segmented ball portion and the second segmented ball portion are coupled to each other, each enclosing half the outer surface of the wire.

According to at least one embodiment of the present disclosure, the housing may include a housing body having a plurality of second hook holes formed on an outer surface thereof; and a housing cover configured to cover the housing body and comprising a plurality of second hooks configured to be coupled to the plurality of second hook holes, wherein the stopper is formed on the housing body.

According to at least one embodiment of the present disclosure, the stopper may include a pair of first stoppers provided on one longitudinal end of the housing body, and a pair of second stoppers provided on another longitudinal end of the housing body.

According to at least one embodiment of the present disclosure, the pair of first stoppers and the pair of second stoppers may each further include protrusions protruding from an inner surface of the housing body to face each other.

According to at least one embodiment of the present disclosure, a width between the protrusions may be less than a diameter of the ball portion.

According to at least one embodiment of the present disclosure, an inner width of the housing may be equal to the diameter of the ball portion, and a longitudinal spacing between the pair of first stoppers and the pair of second stoppers is equal to a length of the through-hole.

According to at least one embodiment of the present disclosure, a protective pad may be provided on the inner surface of the housing to enclose the clip.

According to embodiments of the present disclosure, there may be an effect of improving the workability of fastening a high-voltage connector using a movable clip adapted to absorb a wiring slack length of, and maintain a path for, the high-voltage wire.

The effects that can be achieved from the present disclosure are not limited to those described above, and other effects not described above may also be clearly understood by those having ordinary skill in the art from the following description.

### BRIEF DESCRIPTION OF THE DRAWINGS

FIG. 1 is a perspective view of a movable high-voltage wire protector installed on a high-voltage wire according to an embodiment of the present disclosure.

FIG. 2 is an exploded perspective view of a movable high-voltage wire protector according to an embodiment of the present disclosure.

FIG. 3 is a view showing a movable clip installed in a housing of a movable high-voltage wire protector according to an embodiment of the present disclosure.

FIG. 4 is a cross-sectional view of FIG. 3.

FIG. 5 is a drawing showing the cross-sectional view shown in FIG. 4 with a first segmented ball portion separated from a second segmented ball portion according to an embodiment of the present disclosure.

FIGS. 6A-6C are diagrams sequentially showing directions in which a high-voltage wire moves to reduce the tension of the wire when connecting a connector in a movable high-voltage wire protector according to an embodiment of the present disclosure.

FIGS. 7A-7C are diagrams sequentially showing directions in which a movable clip moves inside a housing as the high-voltage wire moves in the directions shown in FIGS. 6A-6C.

### DETAILED DESCRIPTION OF THE DISCLOSURE

Hereinafter, embodiments of the present disclosure are described in detail with reference to the accompanying drawings. The embodiments are not construed as limited to the disclosure and should be understood to include all changes, equivalents, and replacements within the idea and the technical scope of the disclosure.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

In the description of the embodiments, when an element is described as formed “above/on” or “below/under” another element, it may be construed that they are in direct contact, or they are in indirect contact with one or more other elements interposed therebetween. In this case, the use of “above/on” or “below/under” may be based on what is shown in the accompanying drawings, and these terms are used only to indicate a relative positional relationship between elements for the convenience of description but may not be used to limit the actual positions of the elements. For example, “B above/on A” is intended only to indicate that B is shown above/on A in the drawings, unless otherwise stated or unless the properties of A or B require that A be located above/on B. In actual implementations, B may be located below/under A, or B and A may be disposed in parallel.

In addition, the thickness or size of each layer (film), region, pattern, or structure in the drawings does not necessarily indicate the actual size, as it may be modified for clarity and convenience of description.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

When a component, device, element, or the like of the present disclosure is described as having a purpose or performing an operation, function, or the like, the component, device, or element should be considered herein as being “configured to” meet that purpose or to perform that operation or function.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, embodiments are described in detail with reference to the accompanying drawings, but the same or corresponding components are assigned the same reference numerals regardless of the drawings, and the repeated description thereof have been omitted.

According to at least one embodiment of the present disclosure, a movable high-voltage wire protector 100 may include a movable clip 130, a housing 220, and a stopper 260, 290.

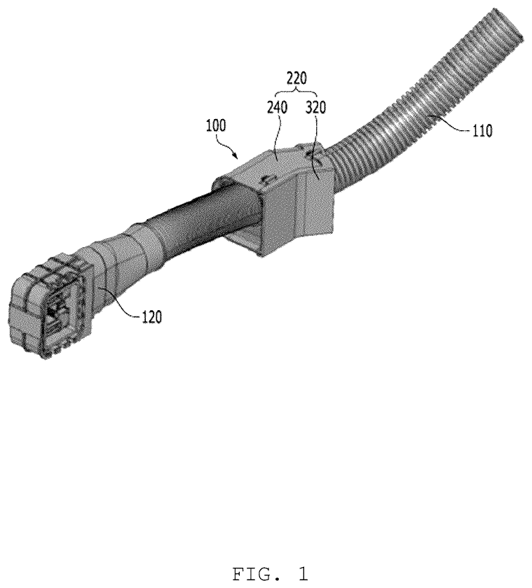

The movable clip 130 may be installed on a high-voltage wire 110, as shown in FIG. 1. The high-voltage wire 110, which is a wire used in an electric or hybrid vehicle, may be used to provide electric power to a motor that supplements or replaces the power of an engine. The high-voltage wire 110 may be characterized by its considerably thick conducting wire due to a large amount of current flowing therein and a corrugated portion formed to allow it to be bent easily.

The movable clip 130 may be installed on an outer surface of the high-voltage wire 110 to be fixed thereto.

Specifically, the movable clip 130 may include a ball portion having a through-hole and having an outer surface in a spherical shape.

The movable clip 130 may include the ball portion provided in the form of a ball, which may move freely within the housing 220, as is described below. For example, it may be reciprocated or rotated between a first stopper 260 and a second stopper 290, which is described below, provided on both sides of the housing 220 to absorb a slack length of the high-voltage wire 110.

The ball portion may include a first segmented ball portion 140 and a second segmented ball portion 180, which are at least two portions into which the ball portion is divided to allow the ball portion to be installed on the outer surface of the high-voltage wire 110.

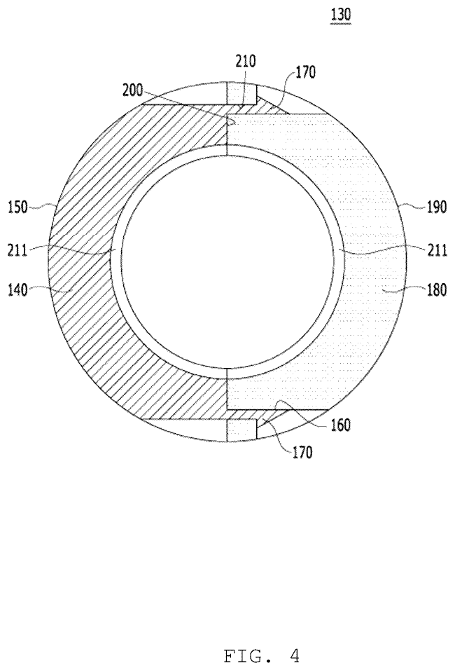

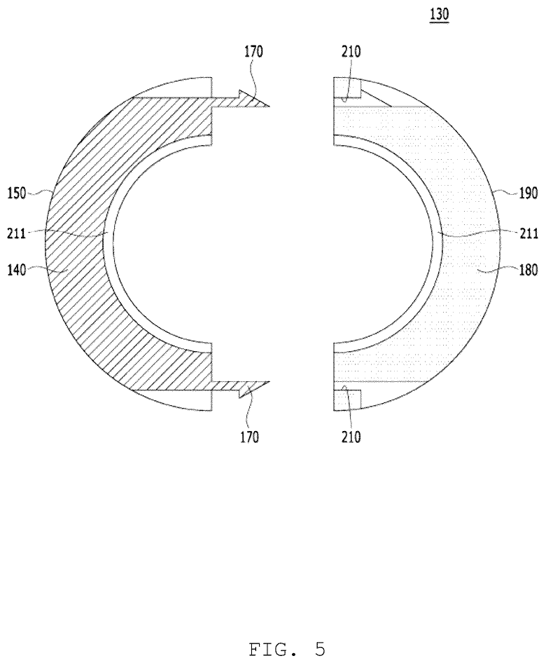

The first segmented ball portion 140 may include a first outer portion 150, and a first end portion 160 from which a plurality of first hooks 170 further protrudes as shown in FIGS. 4 and 5.

The second segmented ball portion 180 may include a second outer portion 190, and a second end portion 200 having a plurality of first hook holes 210 into which the plurality of first hooks 170 are insertable as shown in FIGS. 4 and 5.

As the plurality of first hooks 170 are inserted into the plurality of first hook holes 210, the first segmented ball portion 140 and the second segmented ball portion 180 may be coupled to be engaged while each enclose half the outer surface of the high-voltage wire 110.

The through-hole formed when the first segmented ball portion 140 and the second segmented ball portion 180 are coupled may have a plurality of corrugated grooves 211 corresponding to corrugations of the high-voltage wire 110. The plurality of corrugated grooves 211 is formed on an inner surface of the through-hole and configured to be installed between corrugations of the high-voltage wire 110. This may limit a movement of the movable clip 130 in a longitudinal direction of the high-voltage wire 110.

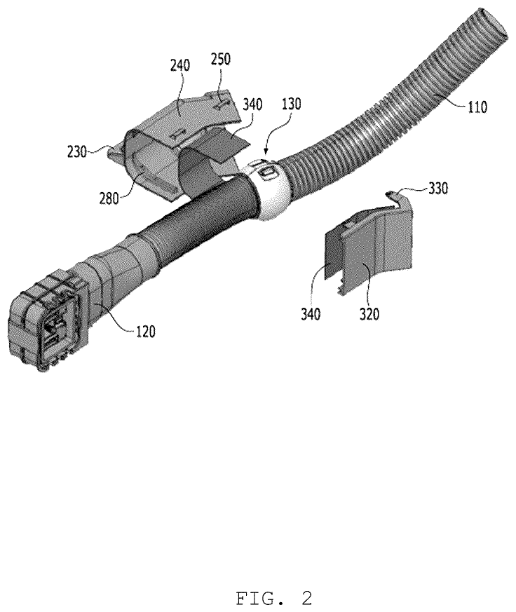

The housing 220 may be secured to a vehicle body, with both longitudinal ends being open for the high-voltage wire 110 to pass therethrough. The movable clip 130 is received within the housing 220, as shown in FIGS. 1 and 2.

The housing 220 may have a fixed bolt fastening portion having a fixed bolt hole, which is formed on the outer surface of the housing 220 to be secured to the vehicle body.

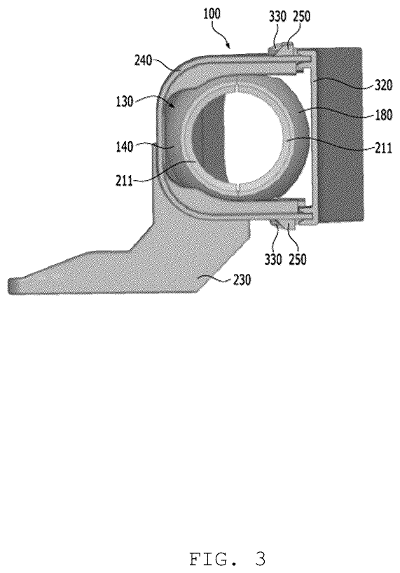

Referring to FIG. 3, an inner width of the housing 220 may be equal to a diameter of the ball portion, and a longitudinal spacing between the first stopper 260 and the second stopper 290, which is described below, may be equal to or greater than a length of the through-hole.

Referring to FIG. 2, the housing 220 may include a housing body 240 and a housing cover 320.

The housing body 240 may be configured to be open at one side and have a plurality of second hook holes 250 formed on an outer surface thereof.

The housing cover 320 may be coupled to the housing body 240 to cover the open side of the housing body 240. The housing cover 320 may have a plurality of second hooks 330 configured to be coupled to the plurality of second hook holes 250.

The stopper 260, 290 may be provided on or near both longitudinal ends of the inner surface of the housing 220 to limit a longitudinal movement of the movable clip 130 inside the housing 220.

Referring to FIG. 3, the stopper may be formed on an inner surface of the housing body 240. Specifically, the stopper may include the first stopper 260 formed on the inner surface on one (i.e, first) longitudinal end of the housing 220.

The stopper may also include the second stopper 290 formed on the inner surface on the other (i.e., second) longitudinal end of the housing 220.

The first stopper 260 may be provided as a pair (i.e., first stopper pair) on one (e.g., the first) longitudinal end of the housing body 240. The second stopper 290 may also be provided as a pair (i.e., second stopper pair) on the other (e.g., second) longitudinal end of the housing body 240.

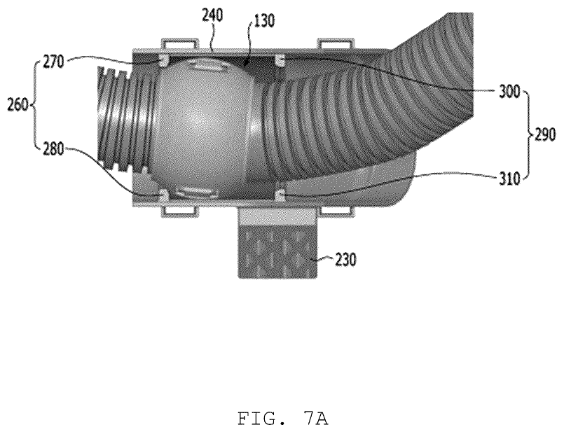

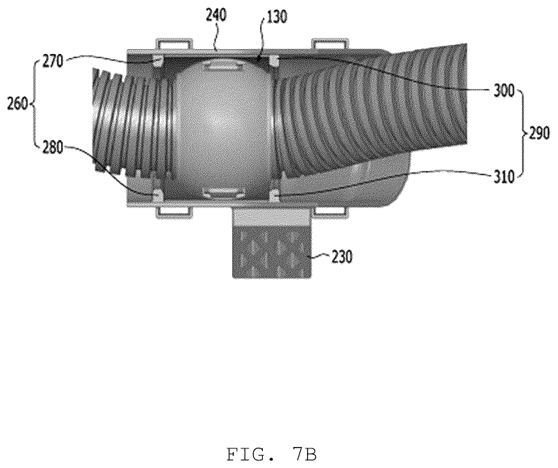

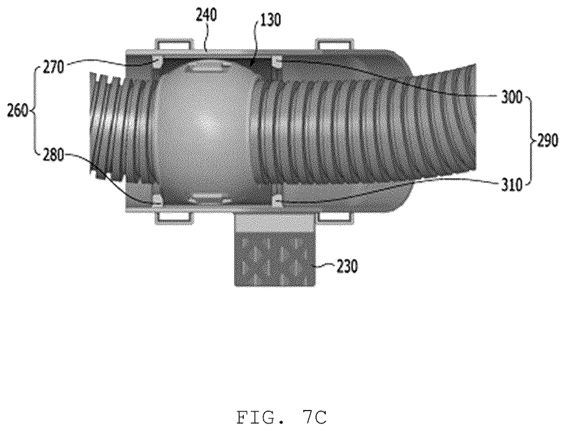

The first stopper pair 260 may include a first protrusion 270 formed at an upper end or side of the housing body 240 and a second protrusion 280 formed at a lower end or side of the housing body 240, as shown in FIGS. 7A-7C.

The second stopper pair 290 may include a third protrusion 300 formed at the upper end or side of the housing body 240 and a fourth protrusion 310 formed at the lower end or side of the housing body 240, as shown in FIGS. 7A-7C.

The width or distance between the first protrusion 270 and the second protrusion 280 may be less than the diameter of the ball portion. The width or distance between the third protrusion 300 and the fourth protrusion 310 may also be less than the diameter of the ball portion.

The movable high-voltage wire protector 100 may have a protective pad 340 on the inner surface of the housing 220 to enclose the movable clip 130. The protective pad 340 may include at least one of rubber, urethane, non-woven fabric, and plastic.

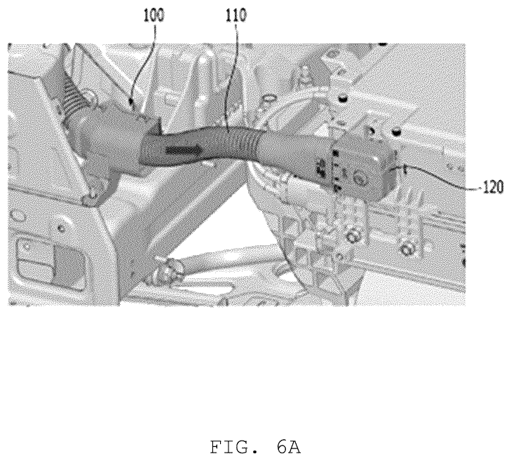

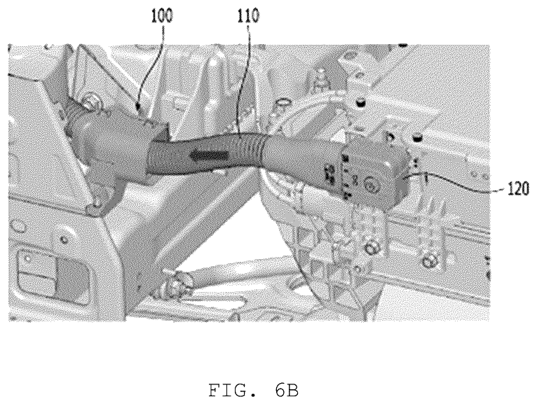

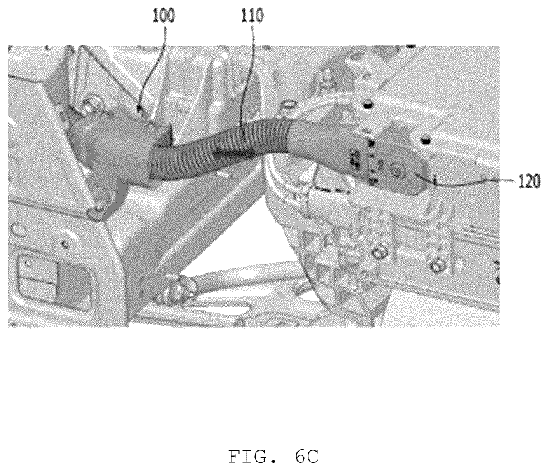

Hereinafter, a process in which, when connecting a connector 120 provided at an end of the high-voltage wire 110, the movable clip 130 absorbs a slack length while moving inside the housing 220 is described with reference to FIGS. 6 and 7.

First, as shown in FIGS. 6A-6C, when the housing body 240 is secured to the vehicle body, the high-voltage wire 110 and the movable clip 130 coupled to the outer surface of the high-voltage wire 110 may be connected.

The movable clip 130 may be connected to the high-voltage wire 110 as described above.

Once the movable clip 130 and the high-voltage wire 110 are installed in the housing body 240, the housing cover 320 may be coupled thereto. In this case, the movable clip 130 may be disposed between the first stopper 260 and the second stopper 290 as shown in FIG. 3.

Once the high-voltage wire 110 and the movable clip 130 are installed in the housing body 240, the housing cover 320 may be coupled to the housing body 240 as shown in FIG. 2.

Once the housing cover 320 is coupled to the housing body 240, the high-voltage wire 110 may be pulled as far as possible in a direction of the connector 120 provided at the end of the high-voltage wire 110 such that the connector 120 is connected to an inverter or junction box, as shown in FIG. 6A and FIG. 7A.

In this case, the movable clip 130 may be pulled in a direction in which the connector 120 is connected or fastened, allowing the movable clip 130 to contact the first stopper 260.

Referring to FIG. 6B and FIG. 7B, when moved into a position for connecting the connector 120, the movable clip 130 may move in an opposite direction, i.e., in a direction of the second stopper 290, to absorb the slack length of the high-voltage wire 110.

When connecting the connector 120 is completed, the movable clip 130 may be disposed between the first stopper 260 and the second stopper 290, as shown in FIG. 6C and FIG. 7C. Therefore, when the connector 120 is installed, this may prevent a rear end of the high-voltage connector 120 of the high-voltage wire 110 from being pinched and broken by wire tension.

While desirable embodiments of the present disclosure have been shown and described above, it should be apparent to one of ordinary skill in the art that various modifications or changes in form and details may be made in these embodiments without departing from the spirit and scope of the claims and their equivalents.

What is claimed is:

1. A wire protector, comprising:
a clip mounted on a wire;
a housing configured to receive the clip, fixed to a vehicle body and having both longitudinal ends open for the wire to pass therethrough; and
a stopper provided on either longitudinal end of an inner surface of the housing to limit a longitudinal movement of the clip inside the housing.

2. The wire protector of claim 1, wherein the clip comprises:
a ball portion having a through-hole.

3. The wire protector of claim 2, wherein the ball portion comprises:
at least two segmented ball portions comprising a first segmented ball portion and a second segmented ball portion,
wherein the first segmented ball portion has a plurality of first hook holes, and
the second segmented ball portion has a plurality of first hooks configured to be coupled to the plurality of first hook holes.

4. The wire protector of claim 3, wherein, when the plurality of first hooks is coupled to the plurality of first hook holes, the first segmented ball portion and the second segmented ball portion are coupled while enclosing an outer surface of the wire.

5. The wire protector of claim 4, wherein the first segmented ball portion and the second segmented ball portion each further comprises:
a corrugated groove formed on an inner surface of the through-hole,
wherein the corrugated groove is configured to be coupled between corrugations of the wire when the first segmented ball portion and the second segmented ball portion are coupled to each other, each enclosing half the outer surface of the wire.

6. The wire protector of claim 2, wherein the housing comprises:
a housing body having a plurality of second hook holes formed on an outer surface thereof; and
a housing cover configured to cover the housing body and comprising a plurality of second hooks configured to be coupled to the plurality of second hook holes,
wherein the stopper is formed on the housing body.

7. The wire protector of claim 6, wherein the stopper comprises:
a pair of first stoppers provided on one longitudinal end of the housing body; and
a pair of second stoppers provided on another longitudinal end of the housing body.

8. The wire protector of claim 7, wherein the pair of first stoppers and the pair of second stoppers each further comprises:
protrusions protruding from an inner surface of the housing body to face each other.

9. The wire protector of claim 8, wherein a width between the protrusions is less than a diameter of the ball portion.

10. The wire protector of claim 7, wherein an inner width of the housing is equal to a diameter of the ball portion, and
a longitudinal spacing between the pair of first stoppers and the pair of second stoppers is equal to a length of the through-hole.

11. The wire protector of claim 1, wherein a protective pad is provided on the inner surface of the housing to enclose the clip.
